(19) United States
(12) Patent Application Publication
(10) Pub. No.: US 2026/0281953 A1
(43) Pub. Date: Sep. 17, 2026

(54) CONGESTION CONTROL AND RESOURCE ALLOCATION FOR SIDELINK POSITIONING REFERENCE SIGNAL TRANSMISSIONS

(71) Applicant: Apple Inc., Cupertino, CA (US)

(72) Inventors: Oghenekome Oteri, San Diego, CA (US); Wei Zeng, Saratoga, CA (US); Haitong Sun, Cupertino, CA (US); Dawei Zhang, Saratoga, CA (US); Chunxuan Ye, San Diego, CA (US)

(21) Appl. No.: 19/472,758

(22) PCT Filed: May 2, 2024
(86) PCT No.: PCT/US2024/027404

§ 371 Date: Oct. 6, 2025

Related U.S. Application Data
(60) Provisional application No. 63/502,113, filed on May 14, 2023.

(51) Int. Cl. H04W 64/00; H04W 72/25

(52) U.S. Cl. CPC H04W 64/00; H04W 72/25

(57) ABSTRACT

Techniques, described herein, include solutions for allocation sidelink positioning reference signals (SL-PRS). In some aspects, various aspects of SL-PRS congestion control, reserving resources for another UE, and inter-UE coordination of using assisting information from an assist UE for SL-PRS resource selection is illustrated for improving SL-PRS communication.

### REFERENCE TO RELATED APPLICATIONS

This Application claims the benefit of U.S. Provisional Application No. 63/502,113, filed on May 14, 2023, the contents of which are hereby incorporated by reference in their entirety

### FIELD

This disclosure relates to wireless communication networks including techniques for allocating sidelink resources within wireless communication networks.

### BACKGROUND

Wireless communication networks may include user equipments (UEs), base stations, and/or other types of wireless devices capable of communicating with one another. During operation, the UEs may communicate with each other via sidelink (sidelink) signaling.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 illustrates an overview diagram illustrating a positioning algorithm involving transmit/receive a sidelink positioning reference signal (SL-PRS) among user equipments (UEs) in accordance with some aspects of the present disclosure.

FIG. 2 illustrates a signaling diagram for Scheme 1 SL-PRS communication in accordance with some aspects of the present disclosure.

FIG. 3 illustrates a block diagram illustrating resource allocation for SL-PRS in accordance with some aspects of the present disclosure.

FIG. 4 illustrates a Scheme 2 signaling procedure to transmit/receive an SL-PRS between UEs involving congestion control in accordance with some aspects of the present disclosure.

FIG. 5 illustrates a logic flow illustrating channel congestion for SL-PRS in accordance with some aspects of the present disclosure.

FIG. 6 illustrates a diagram of time-frequency resource for SL communication and SL-PRS showing examples of definitions of SL-PRS CR and SL-PRS CR limit in accordance with some aspects of the present disclosure.

FIG. 7 illustrates example charts of congestion control processing time in accordance with some aspects of the present disclosure.

FIG. 8 illustrates a block diagram of some examples of resource allocation for SL-PRS in accordance with some aspects of the present disclosure.

FIG. 9 illustrates signaling between multiple UEs including a reserve UE to determine SL-PRS resources for a target UE in accordance with some aspects of the present disclosure.

FIG. 10 illustrates signaling including a reserve UE to determine and indicate a time window for SL-PRS resources of a target UE in accordance with some aspects of the present disclosure.

FIG. 11 illustrates signaling between multiple UEs including a Tx UE to receive and use inter-UE coordination information from an assist UE to allocate resources for transmitting a SL-PRS in accordance with some aspects of the present disclosure.

FIG. 12 illustrates examples of a proactive assistance using IUC scheme 1 and a reactive assistance using IUC scheme 2 in accordance with some aspects of the present disclosure.

FIG. 13 illustrates a process flow for a UE to communicate SL-PRS with a congestion control in accordance with some aspects of the present disclosure.

FIG. 14 illustrates a process flow for a UE to communicate SL-PRS with a coordinated resource reservation in accordance with some aspects of the present disclosure.

FIG. 15 illustrates a process flow for a UE to communicate SL-PRS with an inter-UE coordination information in accordance with some aspects of the present disclosure.

FIG. 16 illustrates a block diagram illustrating a device that can be employed to perform SL-PRS resource allocation in accordance with some aspects of the present disclosure.

FIG. 17 illustrates a block diagram illustrating baseband circuitry that can be employed to perform SL-PRS resource allocation in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless communication networks may include user equipment (UEs) capable of communicating wirelessly with base stations and other network nodes and also UE-to-UE direct communication using sidelink signaling. For sidelink communication between UEs, the resource allocation may be performed using either Scheme 1 or Scheme 2. In Scheme 1, the network (e.g., a base station) allocates resources and communicates the resource allocation to the UEs via Uu operation, and the UEs transmit/receive sidelink signals using the allocated resources. In Scheme 2, a transmitting UE participating in sidelink communication may allocate resources autonomously and communicate data using the allocated resources to one or more other UEs. The sidelink resources may be determined based on a sensing and selection procedure, assisted by resource reservation announcement of other UEs. The resources may be selected and/or reserved from sidelink resource pools, which can be shared by multiple sidelink UEs.

During sidelink operation, information pertaining to the position/location of other UEs (for example, referred as anchor UE) may be used to determine position/location of another UE (referred as target UE). For example, in applications such as vehicle-to-everything (V2X), one UE (e.g., a first vehicle) may utilize a sidelink positioning reference signal (SL-PRS) pertaining to other UEs (e.g., other vehicles or fixed infrastructures) to determine relative position or geographical location and perform operations accordingly. As the needs of sidelink positioning increase, challenges of sufficient and efficient SL-PRS communication involves various aspects of congestion control, resource resource and allocation, and inter-UE coordination (IUC). Transmission SL-PRS in a busy channel without proper congestion control or inter-UE coordination may cause data interference and collision. Improper resource reservation or allocation may result in either resource waste or low transmission success rate. Thereby, part of the continuing optimization of sidelink in wireless networks is to enable and improve the communication of SL-PRS among UEs to facilitate determining positional data of the UEs.

In view of the above, the present disclosure relates to resource allocation techniques for SL-PRS including resource allocation, channel congestion control, inter-UE coordination, as well as other aspects of SL-PRS communication techniques. In some aspects, resources for SL-PRS communication are selected from one or more legacy sidelink resource pools or dedicated SL-PRS resource pools. The dedicated SL-PRS resource pools may be associated with the one or more legacy sidelink resource pools. The resources for SL-PRS may be allocated in sub-channels, which includes a group of resource blocks (RBs) in frequency domain. The resources for SL-PRS may also be allocated in sub-slots in time domain, though the resource pools for SL-PRS may be defined by slots. Using sub-slots improve flexibility and efficiency of resource allocation for SL-PRS. In some further aspects, a congestion handling is performed based on a (pre)congestion control limit, such that resources can be allocated to accommodate transmission priorities and reduce interference. A congestion handling for SL-PRS is performed. Parameters for determining a SL-PRS congestion are defined, and parameters of SL-PRS may be modified during the congestion handling in order to reduce SL-PRS transmission and thus improve congestion. In some further aspects, a serve UE can reserve a SL-PRS resource for the transmission of another UE. In some further aspects, an assist UE can provide resource reservation information of a third-party UE to a target UE, such that resource allocation for the SL-PRS transmission of the target UE is enhanced with information form the third-party UE, which is not directly available to the target UE. As such, sidelink positioning utilizing SL-PRS is specified and improved by defining resource pools, allocating resources, controlling congestion, as well as coordinating resource reservation and selections for different UEs. Additional aspects and details of the disclosure are further described below with reference to figures.

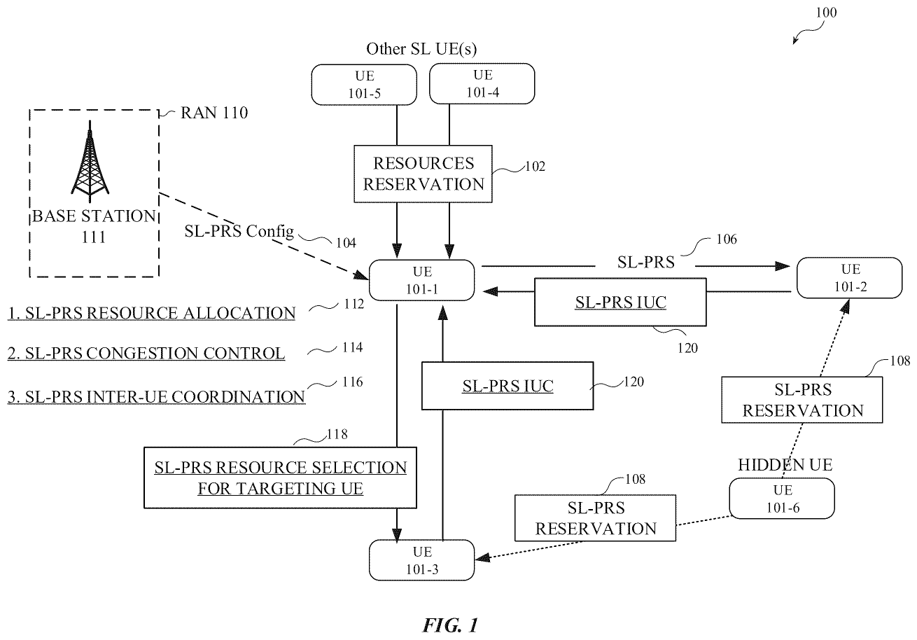

FIG. 1 is an overview diagram illustrating a positioning algorithm involving transmit/receive a sidelink positioning reference signal (SL-PRS) among user equipments (UEs) in accordance with some aspects of the present disclosure. A plurality of UEs such as UEs 101-1, 101-2, 101-3, 101-4, 101-5, 101-6 (also referred as UEs 101 hereafter) is configured to perform sidelink data communication and transmit/receive SL-PRS using related methods and operations, in accordance with some aspects of the present description.

The UE 101-1 is shown as a transmitting UE having sidelink data to be transmitted to a receiving UE such as the UE 101-2. In some aspects, the UE 101-1 sends an SL-PRS to the UE 101-2. In turn, the UE 101-2 measures the SL-PRS. Based on the measurement of the SL-PRS, the UE 101-2 may obtain some positional data pertaining to a position of the UE 101-1 relative to the UE 101-2. In case of resource allocation Mode 2, the transmitting UE 101-1 autonomously determines resources to use for transmitting SL-PRS at 106 based on a sensing and resource selection procedure. The sensing and resource selection procedure considers resource reservations 102 received during a sensing window from other UEs 101-2, 101-3, 101-4 etc. The resource reservations 102 that may be broadcasted by the other UEs 101-2, 101-3, 101-4 as part of a first stage SCI transmitted over a physical sidelink control channel (PSCCH). The resources may be reserved and/or selected from one or more shared resource pools for sidelink communication or one or more dedicated resource pools dedicated for SL-PRS. The resource pools can be shared by multiple UEs 101.

As shown by the first overview point at 112 and discussed in more detail later on, some aspects of the present disclosure relates to SL-PRS resource allocation including, for example, defining minimum resource allocations in time and frequency domain and how various SL-PRS parameters are defined and acquired. As shown by the second overview point at 114 and discussed in more detail later on, some additional aspects of the present disclosure relates to SL-PRS congestion control. Various aspects of the congestion control mechanisms for SL-PRS resource allocation are specified, such as SL-PRS CR and SL-PRS CBR definitions and determination, as well as specifying SL-SPR parameters that can be modified to reduce congestion. As shown by the third overview point at 116 and discussed in more detail later on, some additional aspects of the present disclosure relates to IUC coordination for SL-PRS. The UE 101-1 acting as a reserve UE to select and reserve a SL-PRS resource at act 118 for the transmission of another UE 101-3 acting as a target UE can be supported. In addition, in some scenarios, a hidden UE 101-6 locates out-of-range of a scheduling UE, such as the reserve UE 101-1. SL-PRS resource reservation 108 of the hidden UE 101-6 cannot directly transmit to the reserve UE 101-1 for consideration when scheduling a SL-PRS, which may result in data collision or interference. In some aspects, an assist UE, such as the UE 101-2 or the UE 101-3 can receive the SL-PRS resource reservation 108 and relay or process it and thereby transmit a SL-PRS IUC information 120 to the UE 101-1. Thus, resource allocation by the UE 101-1 is enhanced with the SL-PRS IUC information 120.

A base station 111 of a radio access network (RAN 110) may provide resource allocation when participating in Scheme 1 communication and also provide configuration information to one or more UEs 101 for SL-PRS when connected. Also, an out-of-range UE (e.g., the UE 101-2) may participate in Scheme 1 sidelink by communicating with another UE that is in coverage. For example, if the UE 101-1 is in coverage, the base station 111 may send the resources allocation to the UE 101-1, and the UE 101-1 may “forward” or “relay” configuration information and the resource allocation to an out-of-range UE 101-2. While any of the UEs 101 may not be covered at certain point of time or all the time by a radio cell of a Radio Access Network (RAN) node such as the base station 111 and still be able to communicate with one another automatously using sidelink, one or more of the UEs 101 may also communicate and establish a connection with (e.g., be communicatively coupled with) the base station 111.

The UEs 101 may comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN” or the like can refer to a RAN 110 that operates in an LTE or 4G system.

### SL-PRS Resource Allocation

In Scheme 2 SL-PRS communication, a UE autonomously allocate resources in time and frequency for SL-PRS without acquiring resource allocation from a base station. The set of resources may be selected from one or more SL-PRS resource pools. In some aspects, a resource pool is a subset of the available resources of resource blocks (RBs) and symbols (pre)configured to be used by several UEs for SL data or signal communications. SL-PRS shares some legacy sidelink resource pools with sidelink data communication (named “shared resource pools”) and also has other resource pools dedicated to SL-PRS communication (named “dedicated resource pools”). Notably, the sidelink data communication is also referred as “sidelink communication” throughout this specification, which does not mean to include sidelink reference signal communication. A dedicated resource pool for SL-PRS may be associated with one or more legacy sidelink resource pools or shared resource pools, such as including a selected group of slots dedicated to the SL-PRS communication in the one or more legacy sidelink resource pools or the shared resource pools.

In some aspects, a resource pool for SL-PRS is divided into a number of sub-channels, and the resources for SL-PRS are indexed by sub-channels. Each sub-channel consists of time and frequency resources such as a group of RBs in one or more slots. The number of RBs in a sub-channel corresponds to a sub-channel size. The sub-channel size can be defined or (pre)configured. For example, a sub-channel can be defined as consisting of a group of 4, 10, 15, 20, 25, 50, 75, 100 RBs and one slot. A SL-PRS may be allocated one or multiple sub-channels. A number of sub-channels allocated to a SL-PRS can be (pre)configured. In some aspects, the group of RBs or the sub-channel in frequency domain for SL-PRS is the same as that for sidelink communication. In some alternative aspects, the group of RBs or the sub-channel in frequency domain for SL-PRS is separately pre-defined or (pre)configured for the entire system, since frequency resource needs for sidelink communication and SL-PRS are different. In some aspects, a SL-PRS is allocated a (pre)configured number of RB groups or sub-channels. The number and location of RB groups or sub-channels may be indicated by a start RB group and an end RB group, or a start RB group and a number of RB groups. In some further aspects, the resource allocation for SL-PRS in frequency domain is indicated by RBs. For example, a SL-PRS resource may be defined by reference to parameters including: a start PRB and an end PRB, or a start PRB and a frequency range. The parameters for a SL-PRS resource may further include a SL-PRS comb size and a comb offset. The SL-PRS comb size indicates an interval number of subcarriers for every 12 subcarriers is used. The comb offset indicates a subcarrier offset from the edge of resource block. For example, a comb size 4 with a comb offset 0 indicates subcarriers 0, 4, 8, of a resource block are used for SL-PRS, while a comb size 6 with a comb offset 1 indicates subcarriers 1 and 7 of a resource block are used for SL-PRS. The parameters for a SL-PRS resource may further include SL-PRS periodicity for periodic and/or semi-persistent SL-PRS.

In time domain, the resources for SL-PRS may be allocated in a minimum time unit smaller than a minimum time unit for sidelink communication, such that SL-PRS can be more timely scheduled as well as improving resource efficiency, considering SL-PRS usually requires a shorter transmission. In some aspects, the minimum time unit is a pre-defined number of symbols such as a sub-slot with a time unit duration smaller than a slot. In NR sidelink, the number of slots in a subframe is equal to 2μ, where μ is the SCS configuration factor. As the subframe duration is 1 ms, the slot duration is given by 2^{-μ}ms. Thus, a larger SCS results in a shorter slot duration. Depending on whether a normal CP or a longer extended CP is used, each slot consists of 14 or 12 OFDM symbols, respectively. The OFDM symbols are also simply referred as symbols throughout this specification. As mentioned, a sub-slot has a duration less than a slot. For example, a sub-slot can be one single symbol, or multiple symbols, such as 2, 4, 6, 8 symbols. In one aspect, the size of the sub-slot is pre-defined. Alternatively, the size of the sub-slot is (pre)configured. In one aspect, each SL-PRS can be allocated only one sub-slot or a fixed and pre-defined number of sub-slots. Alternatively, a SL-PRS is allocated a (pre)configured number of sub-slots. The number of sub-slots may be indicated by a start sub-slot and an end sub-slot, or a start sub-slot and a time duration. In some aspects, the sub-slots are defined across boundaries of slots or subframes and may be indicated through indexing. In some further aspects, the resource allocation for SL-PRS in time domain is indicated by symbols. For example, a SL PRS resource may be defined by reference to a SL PRS start symbol and a number of SL PRS symbols. In some additional aspects, the time domain resource is implicitly defined by a duration of the sidelink resource. The sidelink resource is configured with a desired number of symbols. A resource allocation can be indicated by a start symbol of the assigned resource. In some aspects, SL-PRS resources that a FDM or comb multiplexed will have (a) the same time domain size, (b) different time domain sizes but pre-defined boundaries, or (c) entirely flexible defined by symbols.

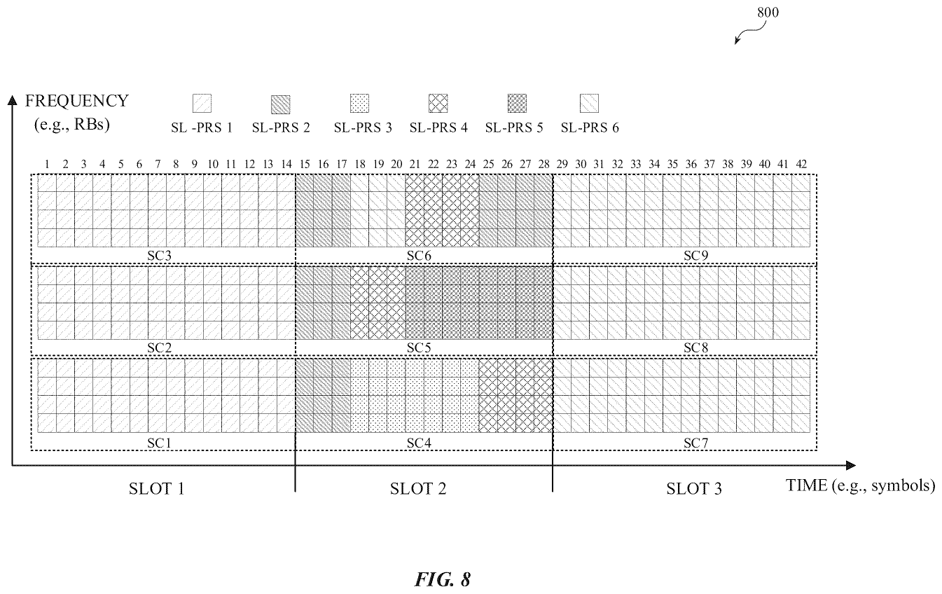

FIG. 8 shows a diagram 800 of some examples of resource allocation for SL-PRS in accordance with some aspects of the present disclosure. Though the sub-channel is defined, resource allocation for SL-PRS may include either an integer or a fractional number of sub-channels. In some aspects, for SL-PRS allocation using shared resource pools, SL-PRS resources can be allocated based on integer number of subchannels for SL-communications or separate number of subchannels for SL-PRS. In other aspects, for SL-PRS allocation using dedicated resource pools, SL-PRS resources can be allocated including a fractional number of subchannels, which is a ratio of a number of resource elements occupied by SL-PRS to a number of resource elements per subchannel. As some examples, SL-PRSs 1-6 in FIG. 8 are respectively allocated 3, 13/14, 7/14, 11/14, 8/14, and (3+3/14) subchannels.

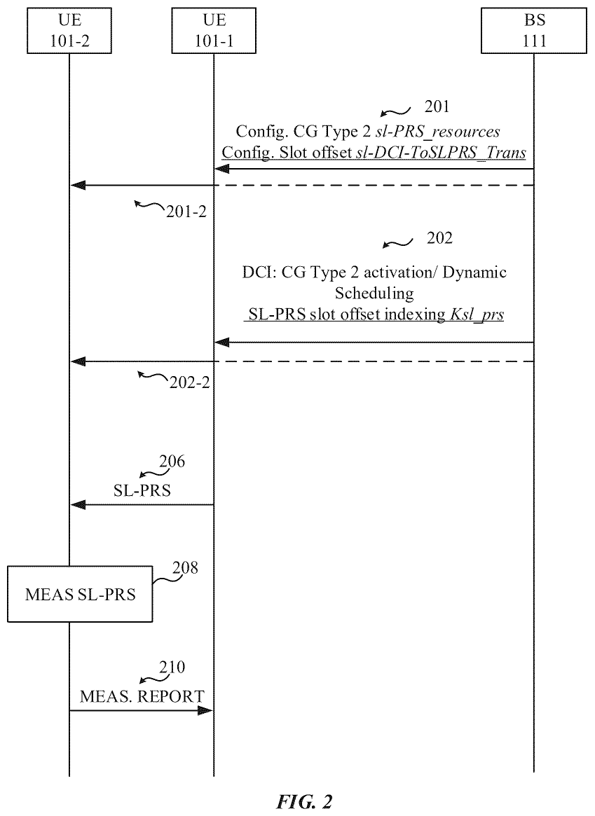

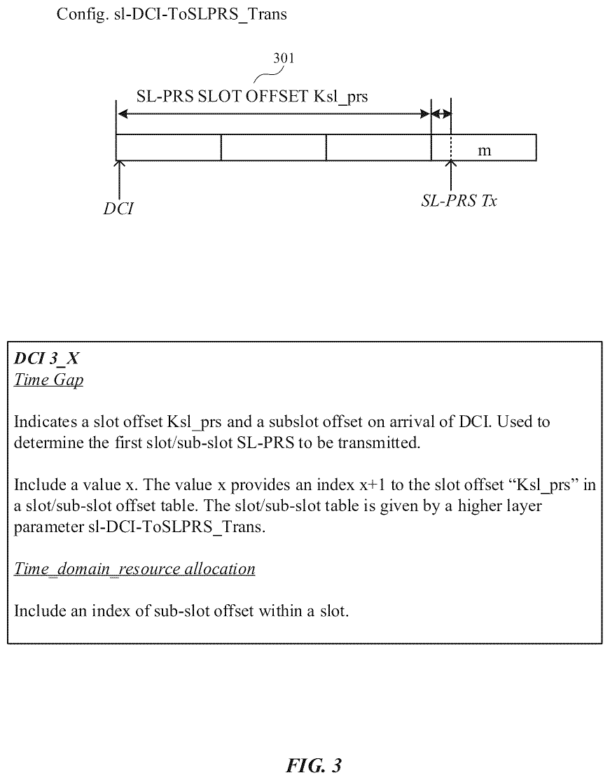

FIG. 2 illustrates a signaling diagram for Scheme 1 SL-PRS communication in accordance with some aspects of the present disclosure. UEs 101-1, 101-2 receive configuration and control information from a base station 111 to allocate time-frequency resources for a SL-PRS communication. In some aspects, as also illustrated in FIG. 3, a slot offset 301 and/or a sub-slot offset 302 are indicated in the control information transmitted by the base station 111 to the UEs 101-1, 101-2 to determine the first slot/sub-slot/symbol a SL-PRS to be transmitted. In some aspects, the slot offset 301 and/or the sub-slot offset 302 is included in a DCI and may be indexed to a SL-PRS offset table provided by a higher layer parameter.

Referring back to FIG. 2, as shown by act 201, in some aspects, the SL-PRS is scheduled using type sidelink 2 configured grant. The base station 111 sends a configured grant configuration to the UE 101-1 to configure the type 2 configured grant. In some aspects, at act 201-2, the base station 111 additionally sends the configured grant configuration to the UE 101-2 to indicate the type 2 configured grant. In some aspects, the configured grant configurations are included in high layer communication such as radio resource control (RRC) signaling. In some alternative aspects, the UE 101-2 is not in coverage of the base station 111. In this scenario, at act 202-2, the UE 101-1 forwards the resource allocation to the UE 101-2 via sidelink, allowing the UE 101-2 to receive the resource allocation without communicating with the base station 111. In some aspects, resources for SL-PRS may be indicated, for example, in a RRC IE sl-PRS_resources. Upon reception of the configured grant configuration, the type 2 configured grant is configured, but is not activated until an activation command is received.

As shown by act 202, the base station 111 activates the type 2 configured grant and/or additionally or alternatively specifies the resources for SL-PRS to be used. In addition, in some alternative aspects, the SL-PRS may be scheduled using sidelink dynamic scheduling, where the base station 111 sends a resource allocation to the UE 101-1 indicating time-frequency resources for transmitting the SL-PRS. In some aspects, the base station 111 may also send the resource allocation to the UE 101-2 for receiving the SL-PRS. Alternatively, as shown by act 202-2, the UE 101-1 may forward the configured grant activation and/or SL-PRS resource indication to the UE 101-2 (e.g., if the UE 101-2 is not in coverage of the base station 111). The resource allocations may be included in control information such as downlink control information (DCI). The time-frequency resources may be indicated, for example, in a SL-PRS resource index field SL-PRS resource index of the DCI, which indexed a time-frequency resource for the SL-PRS. The resource allocations may be transmitted on a physical downlink control channel (PDCCH). As discussed, the activation and/or indication may be included in DCI. In some aspects, the DCI is a DCI format 3_0. In some aspects, the DCI has a new DCI format dedicated for grant of SL-PRS, which may be referred to as DCI format 3_X, wherein X is an integral index number such as 2, 3, 4, etc.

The DCI includes a legacy time gap field for determining the first slot to transmit sidelink data on arrival of DCI for resource allocation for sidelink communication. In some alternative aspects, the DCI includes a SL-PRS time gap field for determining the first slot to transmit the SL-PRS. In some aspects, the legacy time gap is used for SL-PRS with a shared resource pool, while the SL-PRS time gap is used for SL-PRS with a dedicated resource pool. In some aspects, the new time gap field includes a value x that provides an index x+1 to SL-PRS slot offset “Ksl_prs” in a slot/sub-slot offset table. In some aspects, the SL-PRS slot offset Ksl_prs is different or smaller than the slot offset for sidelink communication. The slot/sub-slot table is given by a higher layer parameter (e.g., sl-DCI-ToSLPRS_Trans), which configures slot offsets. In some aspect, a sub-slot offset is also indicated by the DCI. The sub-slot offset may be indicated in a separate field (e.g., Time_domain_resource_allocation), which includes an index of sub-slot offset within a slot. The slot/sub-slot table is given by a higher layer parameter (e.g., sl-DCI-ToSLPRS_Trans), which configures sub-slot offsets.

In some aspects, the starting time of the SL-PRS slot can be calculated by: TDL-Ta/2+Ksl_prs×Tslot, where TDL is the starting time of DL slot carrying DCI, TA is the timing advance value corresponding to the TAG of the serving cell on which the DCI is received, Ksl_prs is the slot offset determined by the “time gap” field as discussed above, and Tslot is the slot duration.

At act 206, the SL-PRS is transmitted from a UE 101-1 to a UE 101-2. The UE 101-2 measures the SL-PRS at act 208, and sends a measurement report to the UE 101-1 at act 210. The measurement report may contain or be based on a result of the performed SL-PRS measurement.

### SL-PRS Congestion Control

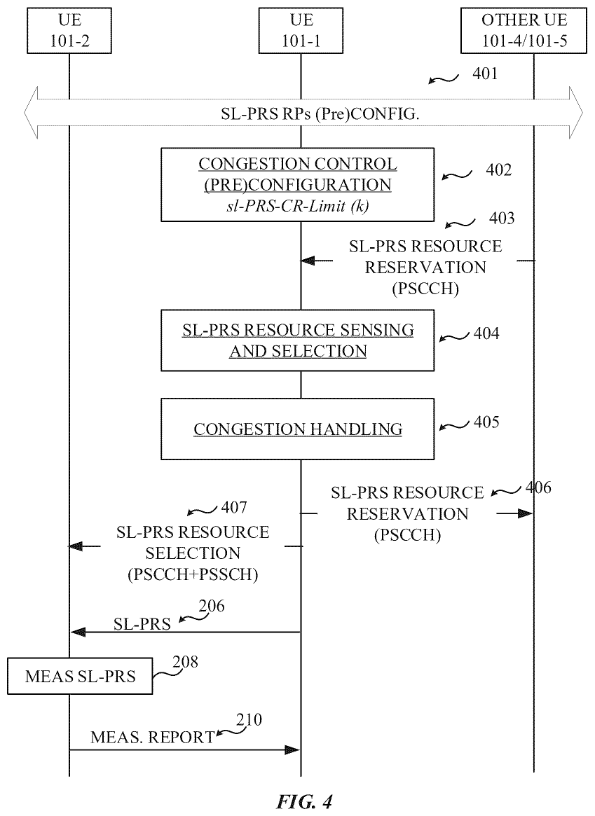

FIG. 4 illustrates a Scheme 2 signaling procedure to transmit/receive an SL-PRS between UEs 101-1, 101-2 involving congestion control in accordance with some aspects of the present disclosure. The UE 101-1 selects time-frequency resources from the at least one resource pool for one or more SL-PRS transmissions. A congestion handling for SL-PRS is performed based on a (pre)congestion control limit. Parameters of SL-PRS may be modified during the congestion handling in order to reduce SL-PRS transmission and thus reduce congestion. As shown by act 401, resource pool information is shared by a plurality of UEs including the UE 101-1 as a transmitting UE and the UE 101-2 as a receiving UE. The resource pool information indicates at least one resource pool for SL-PRS. The resource pool information may be included in a resource pool (pre)configuration signaled from a base station or previously communicated and stored in the UEs or another storage medium without being connected with the base station and thus can be used when one or more UEs are out of coverage. The resource pools may include a dedicated SL-PRS resource pool and/or a shared SL-PRS pool associated with a legacy sidelink resource pool. In some aspects, the shared SL-PRS resource pool includes slots reserved for SL-PRS from an existing sidelink resource pool. The shared SL-PRS resource pool may be associated with a legacy sidelink resource pool, and the reserved SL-PRS slots may be from the legacy sidelink resource pool.

In some aspects, as shown by act 402, congestion control information is received for SL-PRS communication. In some aspects, the congestion control information comprises a SL-PRS channel occupancy ratio (CR) limit indicating a maximum CR. The SL-PRS CR limit may be (pre)configured by a higher layer parameter. For example, the SL-PRS CR limit can be indicated by RRC IE s/-PRS-CR-Limit. In some aspects, a plurality of SL-PRS CR limits is preconfigured respectively associated with a series of priority levels.

As shown by act 404, resources is determined for transmitting a SL-PRS from the UE 101-1 to the UE 101-2. In some aspects, the UE 101-1 selects resources for SL-PRS transmission. As an example, the selection of resources includes decoding SCIs from other UEs (e.g., resource reservation received from UEs 101-4/104-5 on PSCCH as shown by act 403) and comparing reference signal received power (RSRP) associated with the SCIs. The UE 101-1 may choose to not use certain resources if an SCI was received from another UE reserving the resources and the SCI had a high associated RSRP. The SCI indicates the resources have been reserved by another UE, and the high associated RSRP indicates that interference is likely if the UE 101-1 attempts to use the resources.

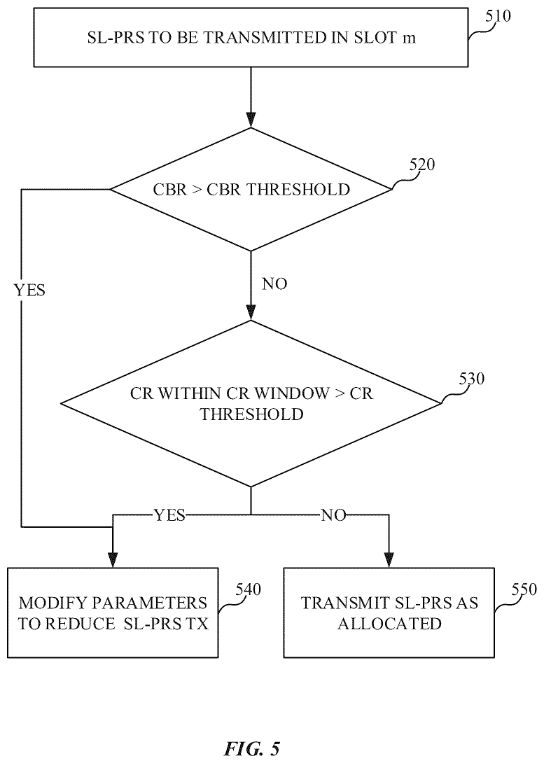

As shown by act 405, a congestion handling is performed based on the congestion control information for the SL-PRS. The resources for transmitting the SL-PRS may be updated if a congestion criteria is met. For example, parameters of the resources may be modified if a SL-PRS CR for transmitting the SL-PRS exceeds a SL-PRS CR limit. More details of the congestion handling will be discussed below associated with FIGS. 5-8 for example.

At act 406, after performing the congestion handling, the UE 101-1 sends a resource reservation to other UE 101-4/101-5 reserving the selected resources. The resource reservation may include an SCI stage 1 format and may be transmitted on PSCCH. Alternatively, the resource reservation may include a single stage SCI and may be transmitted on PSSCH. The single stage SCI is used, for example, for dedicated resource pools.

At act 407, the UE 101-1 sends a resource indication to the UE 101-2 for the UE 101-2 to receive the SL-PRS in the selected resources and decode the SL-PRS. In some aspects, the resource indication may include an SCI stage 1 format transmit on PSCCH followed by an SCI stage 2 format transmit on PSSCH.

In some aspects, the resource reservation/indication includes an index of a resource pool such as shared sidelink resource pool or a dedicated SL-PRS resource pool as described throughout the specification. In some aspects, the resource reservation/indication includes an SL-PRS resource index indicating a time-frequency resource. The SL-PRS resource index may be indicated in a SL-PRS resource index field in a SCI similar as the SL-PRS resource index field in a DCI for dynamic grant as described associated with FIG. 2.

In some aspects, the resource reservation/indication also includes a slot for the SL-PRS transmission. The slot indication could be used in combination with the SL-PRS resource index. For example, the slot indication indicates a slot, and the SL-PRS resource index indicates resources within the slot. In some aspects, the resource reservation/indication also includes a periodicity of the resource reservation, and the resource is periodically reserved according to the periodicity. In some aspects, the resource reservation/indication also includes a time gap. The time gap may be configurable or a pre-determined value. The SL-PRS may be transmitted in the first slot indicated/reserved for SL-PRS after the time gap.

At acts 206, 208, the UE 101-1 transmits the SL-PRS in the indicated/reserved resources, the UE 101-2 receives the SL-PRS in the reserved resources, and the UE 101-2 measures the SL-PRS. After measuring the SL-PRS, the UE 101-2 sends a measurement report including or based on a result of the SL-PRS measurement to the UE 101-1 at act 210.

FIG. 5 is a logic flow illustrating channel congestion for SL-PRS in accordance with some aspects of the present disclosure. In some aspects, a UE will assess one or more channel conditions to determine if channel condition and/or reservation for SL-PRS is overcrowded. Based on the assessment, the UE may modify SL-PRS parameters or even stop transmission of SL-PRS to reduce congestion.

In some aspects, at act 510, the UE has a SL-PRS to be transmitted. As an example, the UE may be the UE 101-1 as described associated with other figures of the specification, such as FIG. 1 or FIG. 4 above. As described, the SL-PRS transmission may be scheduled by a Scheme 2 resource allocation procedure by selecting resources in a selecting window after sensing resource reservations in a sensing window preceding the selecting window.

In some aspects, at act 520, the UE checks if a SL-PRS CBR exceeds a SL-PRS CBR threshold for transmitting the SL-PRS. If the SL-PRS CBR is greater than the SL-PRS CBR threshold value, then the UE may modify parameters of SL-PRS transmission or even stop transmission of SL-PRS at in order to reduce channel congestion, as shown by act 540.

In some aspects, at act 530, the UE checks if a SL-PRS CR exceeds a SL-PRS CR threshold for transmitting the SL-PRS. The SL-PRS CR threshold may be the SL-PRS CR limit discussed above. If the SL-PRS CR is greater than the SL-PRS CR threshold, then the UE may modify parameters of SL-PRS transmission and then transmit the SL-PRS to another UE using the modified resources in order to reduce channel congestion, as shown by act 540.

Alternatively or additional, the UE may even stop transmitting the SL-PRS.

Otherwise, no congestion control procedure is needed, and the SL-PRS can be transmitted as allocated, as shown by act 550. Notably, though FIG. 5 shows both the SL-PRS CBR and the SL-PRS CR are used in a congestion handling procedure, either of the SL-PRS CBR and the SL-PRS CR may be separately used for another congestion handling procedure.

Now more specific details are provided for the CBR/CR evaluation. In some aspects, the SL-PRS CR or the SL-PRS CBR can be evaluated separately from that of sidelink communication and evaluated separately for shared resource pools and dedicated resource pools, such that the congestion condition for the shared resource pools and the dedicated resource pools can be independently determined for accuracy. In some alternative aspects, the SL-PRS CR or the SL-PRS CBR can be evaluated jointly for shared resource pools and dedicated resource pools for simplicity and efficiency. For further simplicity and efficiency, in some further alternative aspects, the SL-PRS CR or the SL-PRS CBR can be evaluated jointly for all sidelink transmission including both the shared resource pools and the dedicated resource pools. Alternatively, the SL-PRS CR or the SL-PRS CBR can be evaluated jointly with sidelink communication only for shared resource pools, while evaluated separately from the sidelink communication for dedicated resource pools. For cases where the SL-PRS CR or the SL-PRS CBR is evaluated jointly with sidelink communication for shared resource pools, in some aspects, the evaluation may be based solely on CR or CBR for sidelink communication, since SL-PRS will be from the same UE and FDMed with PSCCH/PSSCH and thus can have the same CR or BR as the corresponding sidelink communication.

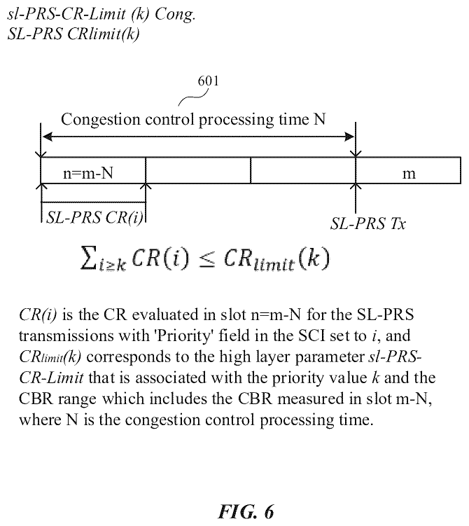

FIG. 6 is a diagram of time-frequency resource for SL communication and SL-PRS showing examples of definitions of SL-PRS CR and SL-PRS CR limit in accordance with some aspects of the present disclosure. For sidelink communication, sidelink CR evaluated at slot n is a total number of sub-channels used for its transmissions in slots [n−a, n−1] and granted in slots [n, n+b] divided by the total number of configured sub-channels in the transmission pool over [n−a, n+b], where a+b+1=1000 or 1000−2μ slots, according to higher layer parameter (e.g. s/-prs-TimeWindowSizeCR), b<(a+b+1)/2, and n+b shall not exceed the last transmission opportunity of the grant for the current transmission. Sidelink CBR measured in a lot n is defined as the portion of sub-channels in the resource pool whose SL RSSI measured by the UE exceed a (pre-)configured threshold sensed over a CBR measurement window [n−a, n−1], wherein a is equal to 100 or 100−2^{μ} slots, according to higher layer parameter sl-Time WindowSizeCBR.

In some aspects, the SL-PRS CR or the SL-PRS CBR is evaluated or measured by normalizing time and frequency resource sizes. In one aspect, the frequency resource may be normalized by SL-PRS resource pools or actual SL-PRS resources. In another aspect, the SL-PRS CR or the SL-PRS CBR is evaluated by normalizing by SL-PRS physical resources, where physical resources=frequency resource assignment (RBs or sub-channels)×time resource assignment (symbols)/(comb-size×staggering ratio), where (comb-size×staggering ratio)=maximum effective comb size. Thus, as an example, the SL-PRS CBR may be measured at slot n, and is the portion of SL-PRS resources in the resource pool whose sidelink received signal strength indicator (RSSI) exceeds an RSSI threshold over a SL-PRS CBR measurement window. The RSSI threshold may be configured or pre-configured.

In a further aspect, the SL-PRS CR or the SL-PRS CBR is evaluated by mapping an SL-PRS resource to a reference SL-PRS resource based on occupied physical resources. The reference SL-PRS resource may be specified or signaled by higher layers. Thus, as an example, the SL-PRS CR evaluated at slot n may be defined as a total number of actual physical resources used for its transmissions in slots [n−a, n−1] and granted in slots [n, n+b] divided by the total number of configured reference resources in the transmission pool over [n−a, n+b].

As an example, the SL-PRS CR or the SL-PRS CBR is estimated and measured for dedicated resource pools. For SL-PRS CR, since SL-PRS have different resource allocation conditions than sidelink communication, parameters for the SL-PRS CR or the SL-PRS CBR can be adjusted by defining (a) frequency domain allocation unit, e.g., sub-channels, (b) number of resource elements per frequency domain allocation unit, which is dependent on the comb structure and if staggering is supported i.e. fully staggered, partially staggered or not staggered, and/or (c) time domain allocation unit, e.g., how many symbols are allocated. In some aspects, frequency and time domain allocation unit (e.g. sub-channel and sub-slot) are pre-defined, while in some other aspects, frequency and time domain allocation unit are (pre-) configured. In some aspects, the SL-PRS CR or the SL-PRS CBR is estimated by a process of firstly defining SL-PRS allocation unit (made up of the frequency domain allocation unit (e.g. sub-channels) and time domain allocation unit (e.g. sub-slot)), then dividing a number of SL-PRS allocation units by a comb-size, and then evaluating a SL-PRS CR at slot n as the total number SL-PRS allocation units divided by the comb size used {or comb-size normalized number of SL-PRS allocation units} for its transmissions in slots [n−a, n−1] and granted in slots [n, n+b] divided by the total number of configured SL-PRS allocation units in the transmission pool over [n−a, n+b].

A SL-PRS CBR is measured in slot n as the portion of PRS-allocation units in the resource pool whose SL RSSI measured by the UE exceed a (pre-)configured threshold sensed over a CBR measurement window [n−a, n−1].

In some further aspects, the SL-PRS CR or the SL-PRS CBR is evaluated using a time window same or separately implemented from a time window for the CR or CBR of sidelink communication. Thus, in some aspects, a SL-PRS CR measurement window is defined as [n−a, n+b], where a and b are determined by UE implementation with parameter values separate and different from those of the sidelink communication. However, similar limitations may still apply: i.e., for SL-PRS CR, a+b+1=1000 or 1000−2μ slots, according to higher layer parameter (e.g. sl-prs-TimeWindowSizeCR), b<(a+b+1)/2, and n+b shall not exceed the last transmission opportunity of the grant for the current transmission. In some aspects, a SL-PRS CBR measurement window is defined as [n−a, n−1], wherein a is equal to 100 or 100−2^{μ} slots, according to higher layer parameter (e.g., sl-prs-TimeWindowSizeCBR).

FIG. 6 shows schematic timing diagrams of a congestion control procedure for SL-PRS. In some aspects, the SL-PRS CR or the SL-PRS CBR is evaluated in a slot n, where n is prior to a first slot m determined for transmitting the first SL-PRS by a congestion control processing time N. In some aspects, SL-PRS CR and the congestion control procedure are defined separately from the legacy sidelink communication. The congestion control processing time Nis a UE capability separately implemented from and may not equal to a congestion control processing time N′ of sidelink communication.

In some aspects, as discussed above associated with FIG. 4 and FIG. 5, a congestion control information for SL-PRS is received comprising a plurality of SL-PRS CR limits respectively associated with a priority level. In some aspects, the SL-PRS to be transmitted is allocated a priority level k. In that case, the SL-PRS CR for the SL-PRS is a sum of all SL-PRS CRs evaluated in a slot n associated with priority levels lower than the priority level allocated to the SL-PRS:

Σ_{i≥k}CR(i)≤CRₗᵢₘᵢₜ(k)

where CR(i) is the CR evaluated in slot n=m−N for the PSSCH transmissions with ‘Priority’ field in the SCI set to i, and CRₗᵢₘᵢₜ(k) corresponds to the high layer parameter sl-PRS-CR-Limit that is associated with the priority value k and the CBR range which includes the CBR measured in slot m−N, where N is the congestion control processing time.

In some other aspects, if the SL-PRS to be transmitted is not allocated a priority level, the SL-PRS may be treated as the highest priority (k=0). The SL-PRS CR for the SL-PRS is a sum of all SL-PRS CRs evaluated in a slot n, and needs to be smaller than a SL-PRS CR limit for k=0.

In some alternative aspects, the PSSCH and SL-PRS congestion control is combined, and the definition of SL-PRS CR or SL-PRS CBR falls back to the legacy definition with CR(i) and CBR modified to incorporate both the PSSCH and SL-PRS transmissions. In that case, the congestion control processing time N for SL-PRS CR can also be the same as a congestion control processing time N′ for sidelink communication.

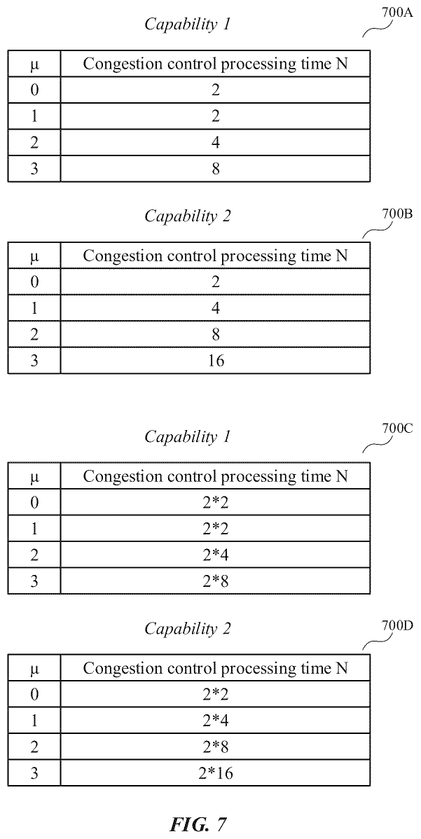

FIG. 7 shows example charts of congestion control processing time in accordance with some aspects of the present disclosure. As shown by charts 700A and 700B, the congestion control processing time N for SL-PRS may be the same as congestion control processing time N′ for sidelink communication. The congestion control processing time N may be a number of slots based on numerology and UE capability. For example, the chart 700A is for a first capability, while the chart 700B is for a second capability. In some alternative aspects, the may be different as congestion control processing time N′ for sidelink communication. For example, the chart 700A is for a first capability and has the congestion control processing time N twice as the control processing time N′ for sidelink communication. Similarly the chart 700B is for a second capability and has the congestion control processing time N twice as the control processing time N′ for sidelink communication.

In some aspects, congestion handling comprises modifying one or more parameters of SL-PRS resources such as increasing a comb-size, reducing a time resource or a frequency resource, or reducing an amount of retransmissions of the first SL-PRS, if a SL-PRS CR for the SL-PRS exceeds the SL-PRS CR limit. A number of SL-PRS resources or a transmission power can also be reduced, in order to reduce and control congestion.

### SL-PRS Inter-UE Coordination

In some cases such as a round trip time (RTT) positioning, SL-PRSs are communicated two ways with a first SL-PRS transmitted from a first UE and received by a second UE and a second SL-PRS transmitted from the second UE and received by the first UE. In these cases, a coordinated timing between the first UE and the second UE is desired in order to arrange the transmission and retransmission of the SL-PRSs. For example, the first SL-PRS and the second SL-PRS are transmitted alternately for RTT with order, and thus the second SL-PRS may be arranged in a time window between two transmissions of the first SL-PRS. For RTT out-of-order, the second SL-PRS may be transmitted or retransmitted after at least two consecutive transmission/retransmission of the first SL-PRS, and thus the second SL-PRS may be arranged in a time window after the at least two consecutive transmission/retransmission of the first SL-PRS. By using one of the first and second UEs to select and reserve resources for both the first and second SL-PRSs, the desired transmission order is easier to achieve.

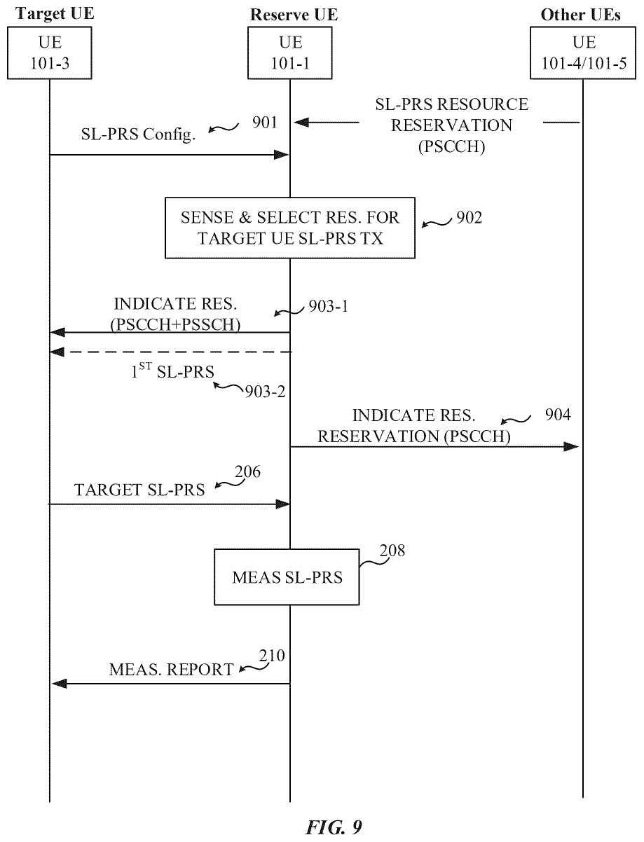

FIG. 9 illustrates signaling between multiple UEs 101 including a UE (e.g. a reserve UE 101-1) to determine SL-PRS resources for another UE (e.g. a target UE 101-3) in accordance with some aspects. In some aspects, the reserve UE 101-1 receives configuration information for SL-PRS communications for the target UE 101-3 (act 901). The reserve UE 101-1 then selects and reserves resources for the target UE to transmit a target SL-PRS (act 902) considering SL-PRS resource reservations received from other UEs 101-4/101-5. The SL-PRS resource reservation may be received on PSCCH. The reserve UE 101-1 then transmits a resource selection information to the target UE 101-3 to indicate the resources for transmitting the target SL-PRS (act 903-1). In some aspects, the resource selected or reserved for the target UE 101-3 is assigned a high priority or indicated with a flag to be prioritized. In some aspects, an RSRP check for the resource selected and reserved for the target UE 101-3 is not performed. By prioritizing the resource selection or reservation for the target UE 101-3, a proper SL-PRS transmission order is achieved for RTT positioning. The resources for transmitting the target SL-PRS may be indicated by a MAC-CE. The resource selection information is transmitted to the target UE 101-3 on a physical sidelink shared channel (PSSCH) with up to two retransmission scheduled. In some aspects, the reserve UE 101-1 also transmits a first SL-PRS to the target UE on the same PSSCH that carries the control information for the target SL-PRS (act 903-2).

The reserve UE 101-1 also transmits to other UEs 101-4/101-5 a sidelink control information (SCI) indicating resource reservation information on a physical sidelink control channel (PSCCH) to reserve the resources for transmission of the target SL-PRS (act 904).

At act 206, the target SL-PRS is transmitted from the target UE 101-3 in the resources indicated by the reserve UE 101-1. In some aspects, the target SL-PRS is transmitted back to the reserve UE 101-1. The reserve UE 101-1 measures the SL-PRS at act 208, and sends a measurement report to the target UE 101-3 at act 210. The measurement report may contain or be based on a result of the performed target SL-PRS measurement.

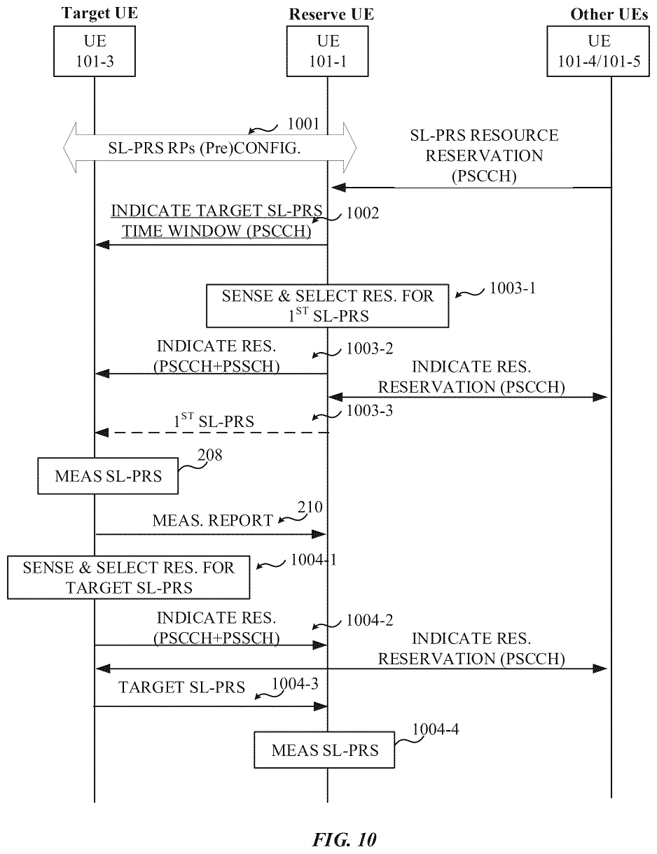

FIG. 10 illustrates signaling between multiple UEs 101 including a UE (e.g. a reserve UE 101-1) to determine and indicate a time window for SL-PRS resources of another UE (e.g. a target UE 101-3) in accordance with some aspects. The actual SL-PRS resource selection and reservation may still be performed by the target UE 101-3. The SL-PRS resource may be assigned with a high priority.

In some aspects, the reserve UE 101-1 and the target UE 101-3 receive configuration information for SL-PRS communications, which for example includes resource pool (pre)configurations for dedicated resource pool for SL-PRS (act 1001). In some aspects, the reserve UE 101-1 then transmit a time window to the target UE 101-3, indicating one or more time frames for SL-PRS resources for the target UE 101-3 to transmit a target SL-PRS (act 1002).

Then, one or more rounds of a first SL-PRS from the reserve UE 101-1 to the target UE 101-3 and a target SL-PRS transmitted in the provided time window the other way around from the target UE 101-3 to the reserve UE 101-1, are communicated (with order or out-of-order as discussed). Though one first SL-PRS followed by one target SL-PRS are described in the following example for illustration purpose, a selected amount and order of the SL-PRSs between the reserve UE 101-1 and the target UE 101-3 can be contemplated. Also, either of the reserve UE 101-1 and the target UE 101-3 can be used as a primary UE for processing the SL-PRSs measurements for both ways for purpose of RTT positioning for example.

As shown by act 1003-1, the reserve UE 101-1 senses, selects, and reserves resources for transmitting a first SL-PRS, considering SL-PRS resource reservations received from other UEs 101-4/101-5 (e.g., on PSCCH) in a sensing window. The reserve UE 101-1 then transmits a resource selection information to the target UE 101-3 to indicate the resources for transmitting the first SL-PRS (act 1003-2). At act 1003-3, the reserve UE 101-1 transmits the first SL-PRS to the target UE 101-3. The reserve UE 101-1 also transmits to other UEs 101-4/101-5 a sidelink control information (SCI) indicating resource reservation information on a physical sidelink control channel (PSCCH) to reserve the resources for transmission of the first SL-PRS. The target UE 101-3 measures the SL-PRS at act 208, and sends a measurement report to the reserve UE 101-1 at act 210. The measurement report may contain or be based on a result of the performed first SL-PRS measurement.

As shown by act 1004-1, in some aspects, the target UE 101-3 senses, selects, and reserves resources for transmitting a target SL-PRS in the time window indicated by the reserve UE 101-1 (e.g., at act 1002). The target UE 101-3 then transmits a resource selection information to the reserve UE 101-1 to indicate the resources for transmitting the target SL-PRS (act 1004-2). Though not shown in FIG. 10, the target UE 101-3 also communicate with other UEs 101-4/101-5 a sidelink control information (SCI) indicating resource reservation information on a physical sidelink control channel (PSCCH). At act 1004-3, the target UE 101-3 transmits the target SL-PRS to the reserve UE 101-1. The reserve UE 101-1 measures the target SL-PRS at act 1004-4. The reserve UE 101-1 may process the measurement result together with the measurement report received from the target UE 101-3 for a RTT positioning, for example. As discussed above, though not explicitly shown in FIG. 10, the measurement reports may be alternatively gathered at the target UE 101-3 for processing.

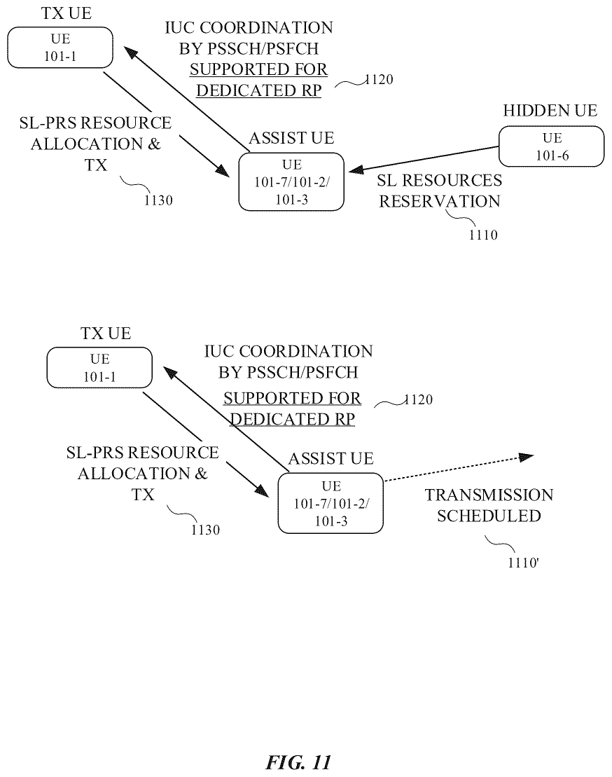

FIG. 11 illustrates signaling between multiple UEs 101 including a first UE (e.g. a Tx UE 101-1) to receive and use inter-UE coordination information from an assist UE (e.g. an assist UE 101-7/101-2/101-3) as shown by act 1120, to allocate resources for transmitting a SL-PRS in accordance with some aspects of the present disclosure. As shown by act 1130, the Tx UE 101-1 then transmits resource allocation information to indicate the resources followed by transmitting the SL-PRS using the selected resources. In some aspects, the transmit UE 101-1 cannot directly receive SL-PRS resource reservation of the hidden UE 101-6, and thus may schedule transmitting SL-PRS on resources interfered with the SL-PRS transmission of the hidden UE 101-6. By using the assist UE 101-7/101-2/101-3 to relay the SL-PRS resource reservation of the hidden UE 101-6 to the transmit UE 101-1, the transmit UE 101-1 could consider the SL-PRS resource reservation of the hidden UE 101-6 in addition to its own sensing result, and thus could schedule better fit SL-PRS resources and reduce potential interference.

In some aspects, as shown by act 1110 of the upper diagram of FIG. 11, the assist UE 101-7/101-2/101-3 receives resource reservation of a hidden UE 101-6. The inter-UE coordination information is based on the resource reservation of the hidden UE 101-6 that may not be directly received by the Tx UE 101-1.

In some further aspects, as shown by act 1110′ of the lower diagram of FIG. 11, the assist UE 101-7/101-2/101-3 transmits the inter-UE coordination information indicating or based on resource allocation/reservation by the assist UE 101-7/101-2/101-3 for transmitting to the Tx UE 101-1. The assist UE 101-7/101-2/101-3 cannot receive the SL-PRS on resources with a transmission scheduled due to half duplex.

In some aspects, the inter-UE coordination information may include preferred/non-preferred resources for proactive assistance using IUC scheme 1. The inter-UE coordination information may be transmitted on PSSCH.

In some other aspects, the inter-UE coordination information may include presence of potential SL-PRS resource conflict of the resource reservation of the Tx UE 101-1 and a resource reservation of hidden UE 101-6, for reactive assistance using IUC scheme 2. The resource allocation of the hidden UE 101-6 is received by the assist UE 101-7/101-2/101-3 and may not be directly received by the Tx UE 101-1. In this case, resource reservation of the Tx UE 101-1 may also be indicated to the assist UE 101-7/101-2/101-3 on SCI received on PSCCH. The inter-UE coordination information is transmitted on physical sidelink feedback channel (PSFCH), such as PSFCH format 0, after comparing the resource allocations of the Tx UE 101-1 and the hidden UE 101-6.

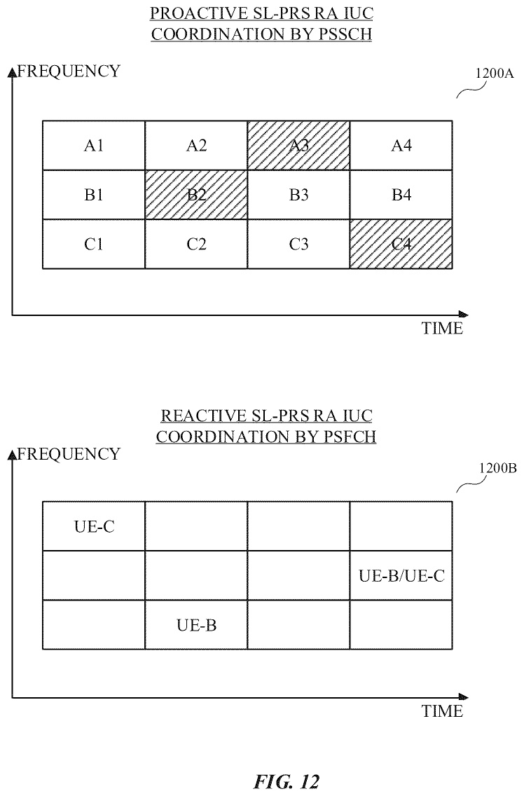

FIG. 12 illustrates examples of a proactive assistance using IUC scheme 1 (diagram 1200A) and reactive assistance using IUC scheme 2 (diagram 1200B) in accordance with some aspects of the present disclosure. As shown by diagram 1200A, an assist UE informs a Tx UE a subset of preferred/available resources {A3, B2, C4} or a subset of non-preferred/unavailable resources {A1, A2, A4, B1, B3, B4, C1, C2, C3}, by sending an inter-UE coordination information on PSSCH for the Tx UE to allocate resources for SL-PRS transmission. As shown by diagram 1200B, an assist UE receives resource allocation of both a Tx UE (the reserved resource units are labeled as UE-B) and another UE (the reserved resource units are labeled as UE-C) and informs the Tx UE of potential SL-PRS resource conflict as illustrated by a resource unit labeled as UE-B/UE-C, by sending an inter-UE coordination information on PSFCH format 0 for the Tx UE to allocate resources for SL-PRS transmission.

In some aspects, the inter-UE coordination information is not supported when the Tx UE is to allocate resources for SL-PRS transmission on a dedicated resource pool, if PSSCH or PSFCH is not configured in a dedicated resource pool for SL-PRS transmission. Alternatively, PSSCH and/or PSFCH are configured in a dedicated resource pool for transmitting inter-UE coordination information when the inter-UE coordination information is configured. Further alternatively, dedicated pool resource is configured with a specific shared pool resource, as PSSCH and/or PSFCH are configured in a shared resource pool for transmitting the inter-UE coordination information. Further alternatively, the inter-UE coordination information can be transmitted on PSSCH and/or PSFCH only if a resource is acquired in a shared resource pool. Otherwise, the inter-UE coordination information may not be transmitted for allocating resources for SL-PRS transmission.

In the shared resource pool, the PSSCH/PSFCH may be assigned a high priority level to allocate channel resources for the inter-UE coordination information to be communicated as soon as possible. In some further aspects, assistance information is included and transmitted in the inter-UE coordination information, indicating parameters such as the time when the resource occupation or conflict was evaluated.

In some aspects, a time window is configured within which the inter-UE coordination information may be reported. In one implementation, if the time window for reporting the inter-UE coordination information is exceeded, the inter-UE coordination information may be discarded. A flag may be sent back to the assist UE informing the discard of the inter-UE coordination information.

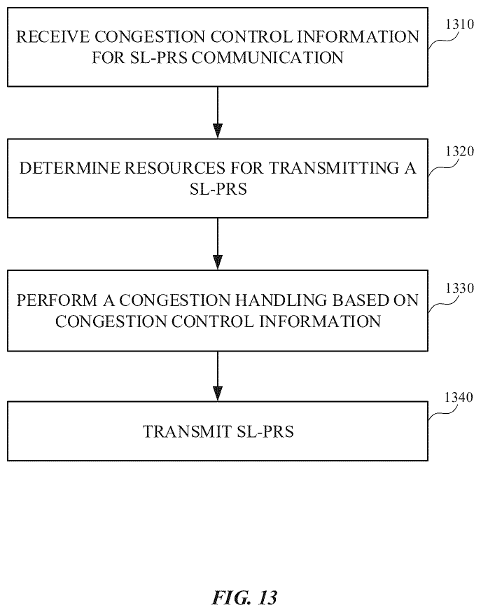

FIG. 13 illustrates a process flow for a UE to communicate SL-PRS with a congestion control in accordance with some aspects of the present disclosure. At act 1310, a UE receives congestion control information for SL-PRS communication. At act 1320, the UE determines resources for transmitting a first SL-PRS to a second UE. At act 1330, a congestion handling is performed based on the congestion control information for SL-PRS communication. At act 1340, the SL-PRS is transmitted to the second UE after performing the congestion handling. Additional process steps and other details described in this disclosure such as associated with the signaling shown in FIG. 4 can be incorporated in the process.

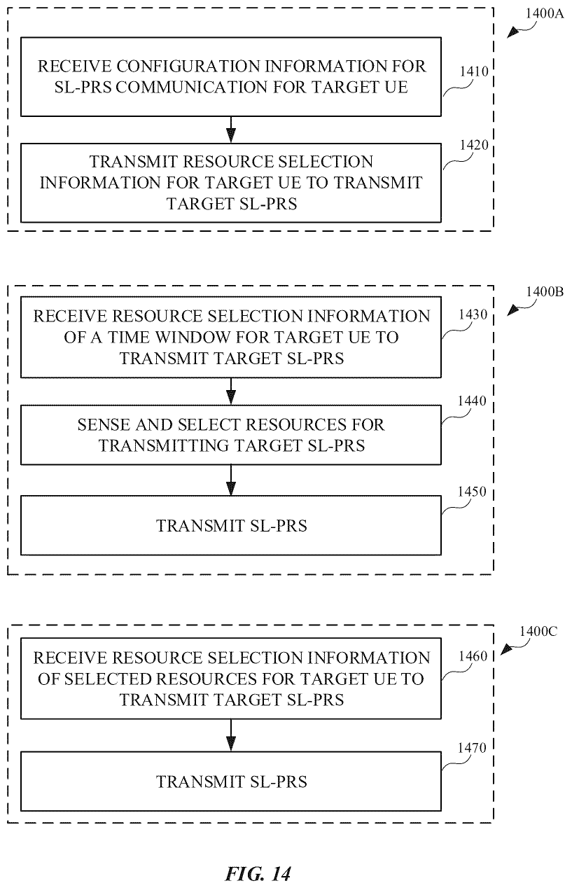

FIG. 14 illustrates a process flow for a UE to communicate SL-PRS with a coordinated resource reservation in accordance with some aspects of the present disclosure. As shown by a flow chart 1400A, in some aspects, a reserve UE receives configuration information for SL-PRS communications for a target UE as shown by act 1410. At act 1420, the reserve UE transmits resource selection information to the target UE to indicate resources for the target UE to transmit a target SL-PRS.

In some aspects, the resource selection information may comprises a time window within which the target SL-PRS is scheduled. The target UE then receives the resource selection information of the time window (act 1430), sense and select the resources for transmitting the target SL-PRS (act 1440), transmit the target SL-PRS using the determined resources (act 1450), as shown by a flow chart 1400B. The time window may be transmitted on a physical sidelink control channel (PSCCH). Additional process steps and other details described in this disclosure such as associated with the signaling shown in FIG. 10 can be incorporated in the process.

Alternatively or additionally, the resources for transmitting the target SL-PRS is included in the resource selection information. The reserve UE may sense select the resources and transmit the information to the target UE with up to two retransmission scheduled. The target UE receives such resource selection information (act 1460), and transmit the target SL-PRS using the selected resources (act 1470), as shown by a flow chart 1400C. Additional process steps and other details described in this disclosure such as associated with the signaling shown in FIG. 9 can be incorporated in the process.

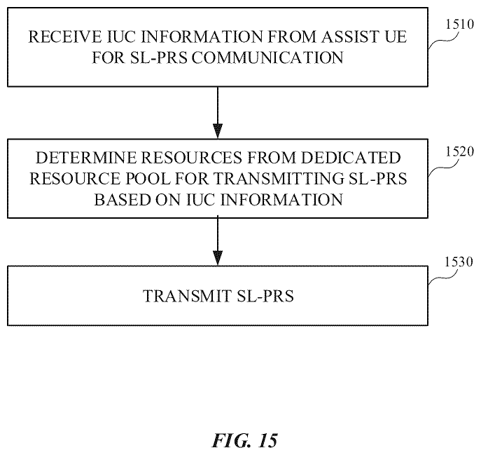

FIG. 15 illustrates a process flow for a UE to communicate SL-PRS with an inter-UE coordination information in accordance with some aspects of the present disclosure. At act 1510, a UE receives, from an assist UE, inter-UE coordination information for allocating resources for transmitting SL-PRS. The UE then determines, based on the inter-UE coordination information, resources from a dedicated resource pool for transmitting the SL-PRS as shown in act 1520. Then, act 1530, the UE transmits the SL-PRS using the resources determined from the dedicated resource pool. In some aspects, a physical sidelink shared channel (PSSCH) or a physical sidelink feedback channel (PSFCH) is configured for communicating the inter-UE coordination information. Additional process steps and other details described in this disclosure such as associated with FIGS. 11-12 can be incorporated in the process.

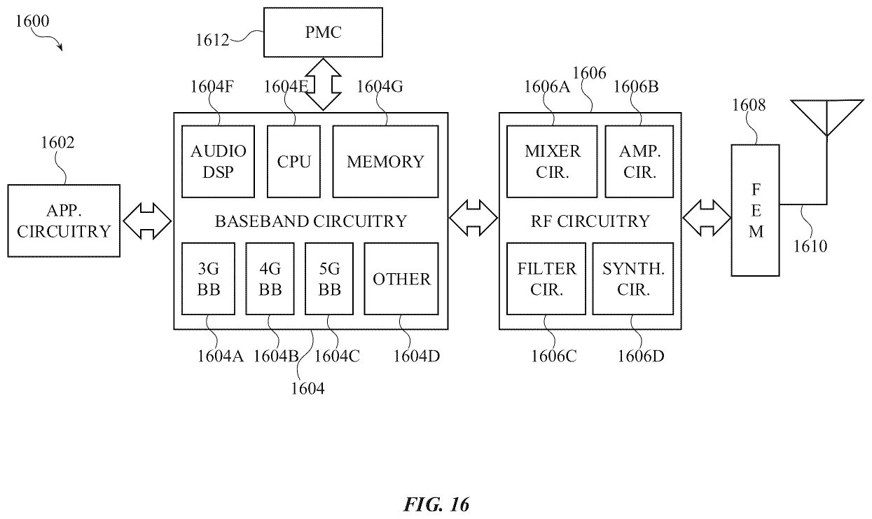

FIG. 16 is a diagram of an example of components of a device according to one or more implementations described herein. In some implementations, the device 1600 can include application circuitry 1602, baseband circuitry 1604, RF circuitry 1606, front-end module (FEM) circuitry 1608, one or more antennas 1610, and power management circuitry (PMC) 1612 coupled together at least as shown. The components of the illustrated device 1600 can be included in a UE or a RAN node, such as the UE 101 or the base station 111 as described throughout the present disclosure. The UE 101 and the base station 111 may be configured to perform SL-PRS resource allocation as described throughout the present disclosure. In some implementations, the device 1600 can include fewer elements (e.g., a RAN node may not utilize application circuitry 1602, and instead include a processor/controller to process IP data received from a core network (CN) such as 5GC or an Evolved Packet Core (EPC)). In some implementations, the device 1600 can include additional elements such as, for example, memory/storage, display, camera, sensor (including one or more temperature sensors, such as a single temperature sensor, a plurality of temperature sensors at different locations in device 1600, etc.), or input/output (I/O) interface. In other implementations, the components described below can be included in more than one device (e.g., said circuitries can be separately included in more than one device for Cloud-RAN (C-RAN) implementations).

The application circuitry 1602 can include one or more application processors. For example, the application circuitry 1602 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1600. In some implementations, processors of application circuitry 1602 can process IP data packets received from an EPC.

The baseband circuitry 1604 can include circuitry such as, but not limited to, one or more single-core or multi-core processors. The baseband circuitry 1604 can include one or more baseband processors or control logic to process baseband signals received from a receive signal path of the RF circuitry 1606 and to generate baseband signals for a transmit signal path of the RF circuitry 1606. Baseband circuitry 1604 can interface with the application circuitry 1602 for generation and processing of the baseband signals and for controlling operations of the RF circuitry 1606. For example, in some implementations, the baseband circuitry 1604 can include a 3G baseband processor 1604A, a 4G baseband processor 1604B, a 5G baseband processor 1604C, or other baseband processor(s) 1604D for other existing generations, generations in development or to be developed in the future (e.g., 2G, 6G, etc.). The baseband circuitry 1604 (e.g., one or more of baseband processors 1604A-D) can handle various radio control functions that enable communication with one or more radio networks via the RF circuitry 1606. In other implementations, some or all of the functionality of baseband processors 1604A-D can be included in modules stored in the memory 1604G and executed via a Central Processing Unit (CPU) 1604E. The radio control functions can include, but are not limited to, signal modulation/demodulation, encoding/decoding, radio frequency shifting, etc. In some implementations, modulation/demodulation circuitry of the baseband circuitry 1604 can include Fast-Fourier Transform (FFT), precoding, or constellation mapping/de-mapping functionality. In some implementations, encoding/decoding circuitry of the baseband circuitry 1604 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1604 can include one or more audio digital signal processor(s) (DSPs) 1604F. The audio DSPs 1604F can include elements for compression/decompression and echo cancellation and can include other suitable processing elements in other implementations.

Components of the baseband circuitry can be suitably combined in a single chip, a single chipset, or disposed on a same circuit board in some implementations. In some implementations, some or all of the constituent components of the baseband circuitry 1604 and the application circuitry 1602 can be implemented together such as, for example, on a system on a chip (SOC).

In some implementations, the baseband circuitry 1604 can provide for communication compatible with one or more radio technologies. For example, in some implementations, the baseband circuitry 1604 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1604 is configured to support radio communications of more than one wireless protocol can be referred to as multi-mode baseband circuitry.

RF circuitry 1606 can enable communication with wireless networks using modulated electromagnetic radiation through a non-solid medium. In various implementations, the RF circuitry 1606 can include switches, filters, amplifiers, etc. to facilitate the communication with the wireless network. RF circuitry 1606 can include a receive signal path which can include circuitry to down-convert RF signals received from the FEM circuitry 1608 and provide baseband signals to the baseband circuitry 1604. RF circuitry 1606 can also include a transmit signal path which can include circuitry to up-convert baseband signals provided by the baseband circuitry 1604 and provide RF output signals to the FEM circuitry 1608 for transmission.

In some implementations, the receive signal path of the RF circuitry 1606 can include mixer circuitry 1606A, amplifier circuitry 1606B and filter circuitry 1606C. In some implementations, the transmit signal path of the RF circuitry 1606 can include filter circuitry 1606C and mixer circuitry 1606A. RF circuitry 1606 can also include synthesizer circuitry 1606D for synthesizing a frequency for use by the mixer circuitry 1606A of the receive signal path and the transmit signal path. In some implementations, the mixer circuitry 1606A of the receive signal path can be configured to down-convert RF signals received from the FEM circuitry 1608 based on the synthesized frequency provided by synthesizer circuitry 1606D.

The amplifier circuitry 1606B can be configured to amplify the down-converted signals and the filter circuitry 1606C can be a low-pass filter (LPF) or band-pass filter (BPF) configured to remove unwanted signals from the down-converted signals to generate output baseband signals. Output baseband signals can be provided to the baseband circuitry 1604 for further processing. In some implementations, the output baseband signals can be zero-frequency baseband signals, although this is not a requirement. In some implementations, mixer circuitry 1606A of the receive signal path can comprise passive mixers, although the scope of the implementations is not limited in this respect.

In some implementations, the mixer circuitry 1606A of the transmit signal path can be configured to up-convert input baseband signals based on the synthesized frequency provided by the synthesizer circuitry 1606D to generate RF output signals for the FEM circuitry 1608. The baseband signals can be provided by the baseband circuitry 1604 and can be filtered by filter circuitry 1606C.

In some implementations, the mixer circuitry 1606A of the receive signal path and the mixer circuitry 1606A of the transmit signal path can include two or more mixers and can be arranged for quadrature down conversion and up conversion, respectively. In some implementations, the mixer circuitry 1606A of the receive signal path and the mixer circuitry 1606A of the transmit signal path can include two or more mixers and can be arranged for image rejection (e.g., Hartley image rejection). In some implementations, the mixer circuitry 1606A of the receive signal path and the mixer circuitry 1606A can be arranged for direct down conversion and direct up conversion, respectively. In some implementations, the mixer circuitry 1606A of the receive signal path and the mixer circuitry 1606A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 1606 can include analog-to-digital converter (ADC) and digital-to-analog converter (DAC) circuitry and the baseband circuitry 1604 can include a digital baseband interface to communicate with the RF circuitry 1606.

In some dual-mode implementations, a separate radio IC circuitry can be provided for processing signals for each spectrum, although the scope of the implementations is not limited in this respect.

In some implementations, the synthesizer circuitry 1606D can be a fractional-N synthesizer or a fractional N/N+1 synthesizer, although the scope of the implementations is not limited in this respect as other types of frequency synthesizers can be suitable. For example, synthesizer circuitry 1606D can be a delta-sigma synthesizer, a frequency multiplier, or a synthesizer comprising a phase-locked loop with a frequency divider.

The synthesizer circuitry 1606D can be configured to synthesize an output frequency for use by the mixer circuitry 1606A of the RF circuitry 1606 based on a frequency input and a divider control input. In some implementations, the synthesizer circuitry 1606D can be a fractional N/N+1 synthesizer.

In some implementations, frequency input can be provided by a voltage controlled oscillator (VCO), although that is not a requirement. Divider control input can be provided by either the baseband circuitry 1604 or the applications circuitry 1602 depending on the desired output frequency. In some implementations, a divider control input (e.g., N) can be determined from a look-up table based on a channel indicated by the applications circuitry 1602.

Synthesizer circuitry 1606D of the RF circuitry 1606 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1606D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1606 can include an IQ/polar converter.

FEM circuitry 1608 can include a receive signal path which can include circuitry configured to operate on RF signals received from one or more antennas 1610, amplify the received signals and provide the amplified versions of the received signals to the RF circuitry 1606 for further processing. FEM circuitry 1608 can also include a transmit signal path which can include circuitry configured to amplify signals for transmission provided by the RF circuitry 1606 for transmission by one or more of the one or more antennas 1610. In various implementations, the amplification through the transmit or receive signal paths can be done solely in the RF circuitry 1606, solely in the FEM circuitry 1608, or in both the RF circuitry 1606 and the FEM circuitry 1608.

In some implementations, the FEM circuitry 1608 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1606). The transmit signal path of the FEM circuitry 1608 can include a power amplifier (PA) to amplify input RF signals (e.g., provided by RF circuitry 1606), and one or more filters to generate RF signals for subsequent transmission (e.g., by one or more of the one or more antennas 1610).

In some implementations, the PMC 1612 can manage power provided to the baseband circuitry 1604. In particular, the PMC 1612 can control power-source selection, voltage scaling, battery charging, or DC-to-DC conversion. The PMC 1612 can often be included when the device 1600 is capable of being powered by a battery, for example, when the device is included in a UE. The PMC 1612 can increase the power conversion efficiency while providing desirable implementation size and heat dissipation characteristics.

While FIG. 16 shows the PMC 1612 coupled only with the baseband circuitry 1604. However, in other implementations, the PMC 1612 may be additionally or alternatively coupled with, and perform similar power management operations for, other components such as, but not limited to, application circuitry 1602, RF circuitry 1606, or FEM circuitry 1608.

In some implementations, the PMC 1612 can control, or otherwise be part of, various power saving mechanisms of the device 1600. For example, if the device 1600 is in an RRC_Connected state, where it is still connected to the RAN node as it expects to receive traffic shortly, then it can enter a state known as Discontinuous Reception Mode (DRX) after a period of inactivity. During this state, the device 1600 can power down for brief intervals of time and thus save power.

If there is no data traffic activity for an extended period of time, then the device 1600 can transition off to an RRC_Idle state, where it disconnects from the network and does not perform operations such as channel quality feedback, handover, etc. The device 1600 goes into a very low power state and it performs paging where again it periodically wakes up to listen to the network and then powers down again. The device 1600 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 1602 and processors of the baseband circuitry 1604 can be used to execute elements of one or more instances of a protocol stack. For example, processors of the baseband circuitry 1604, alone or in combination, can be used execute Layer 3, Layer 2, or Layer 1 functionality, while processors of the baseband circuitry 1604 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

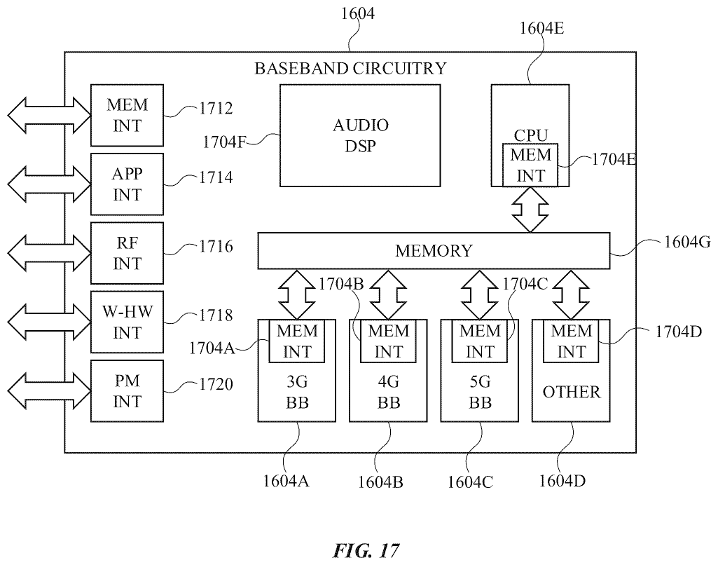

FIG. 17 is a diagram of example interfaces of baseband circuitry according to one or more implementations described herein. As discussed above, the baseband circuitry 1604 of FIG. 16 can comprise processors 1604A-1604E and a memory 1604G utilized by said processors. Each of the processors 1604A-1604E can include a memory interface, 1704A-1704E, respectively, to send/receive data to/from the memory 1604G. The baseband circuitry 1604, or the one or more baseband processors or control logic of the baseband circuitry 1604, may stand alone as the UE 101 or the base station 111 and perform signaling and operations as described throughout the present disclosure.

The baseband circuitry 1604 can further include one or more interfaces to communicatively couple to other circuitries/devices, such as a memory interface 1712 (e.g., an interface to send/receive data to/from memory external to the baseband circuitry 1604), an application circuitry interface 1714 (e.g., an interface to send/receive data to/from the application circuitry 1602 of FIG. 16), an RF circuitry interface 1716 (e.g., an interface to send/receive data to/from RF circuitry 1606 of FIG. 16), a wireless hardware connectivity interface 1718 (e.g., an interface to send/receive data to/from Near Field Communication (NFC) components, Bluetooth® components (e.g., Bluetooth® Low Energy), Wi-Fi® components, and other communication components), and a power management interface 1720 (e.g., an interface to send/receive power or control signals to/from the PMC 1612).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a baseband processor for a first User Equipment (UE). The baseband processor is configured to, when executing instructions stored in one or more memories, cause the first UE to receive congestion control information for sidelink positioning reference signal (SL-PRS) communication, determine resources for transmitting a first SL-PRS to a second UE; perform a congestion handling based on the congestion control information for SL-PRS communication, and transmit the SL-PRS to the second UE after performing the congestion handling.

Example 2 is a baseband processor, including the subject matter of Example 1, wherein the congestion handling is further based on a SL-PRS channel occupancy ratio (CR) and/or a SL-PRS channel busy ratio (CBR) for the first SL-PRS, and wherein the SL-PRS CR or the SL-PRS CBR is evaluated separately for shared resource pools and dedicated resource pools.

Example 3 is a baseband processor, including the subject matter of Example 2, wherein the SL-PRS CR or the SL-PRS CBR is evaluated by normalizing time and frequency resource sizes.

Example 4 is a baseband processor, including the subject matter of Example 2, wherein the SL-PRS CR or the SL-PRS CBR is evaluated using a time window separately implemented from a time window for the CR or CBR of sidelink communication.

Example 5 is a baseband processor, including the subject matter of Example 2, wherein the SL-PRS CR or the SL-PRS CBR is evaluated in a slot n, where n is prior to a first slot m determined for transmitting the first SL-PRS by a congestion control processing time N, and wherein the congestion control processing time Nis a UE capability separately implemented from a congestion control processing time N′ of sidelink communication.

Example 6 is a baseband processor, including the subject matter of Example 1, wherein the congestion control information comprises a SL-PRS channel occupancy ratio (CR) limit, and wherein the congestion handling comprises modifying parameters of the resources, if a SL-PRS CR for the first SL-PRS exceeds the SL-PRS CR limit.

Example 7 is a baseband processor, including the subject matter of Example 6, wherein the SL-PRS CR limit is associated with a priority level allocated to the first SL-PRS, and wherein the SL-PRS CR for the first SL-PRS is a sum of all SL-PRS CRs evaluated in a slot n associated with priority levels lower than the priority level allocated to the first SL-PRS.

Example 8 is a baseband processor, including the subject matter of Example 6, wherein the SL-PRS CR for the first SL-PRS is a sum of all SL-PRS CRs evaluated in a slot n, where n is prior to a first slot m determined for transmitting the first SL-PRS by a congestion control processing time N.

Example 9 is a baseband processor, including the subject matter of Example 6, wherein modifying the parameters of the resources comprises one or more of: increasing a comb-size, reducing a time resource or a frequency resource, or reducing an amount of retransmissions of the first SL-PRS.

Example 10 is a baseband processor, including the subject matter of Example 1, wherein the congestion control information comprises a channel busy ratio (CBR) threshold, and wherein the congestion handling comprises modifying parameters or stopping transmitting the first SL-PRS if a CBR for the first SL-PRS exceeds the CBR threshold value.

Example 11 is a baseband processor for a reserve User Equipment (UE). The baseband processor is configured to, when executing instructions stored in one or more memories, cause the reserve UE to receive configuration information for sidelink positioning reference signal (SL-PRS) communications for a target UE and transmit resource selection information to the target UE to indicate resources for the target UE to transmit a target SL-PRS.

Example 12 is a baseband processor, including the subject matter of Example 11, wherein the resource selection information comprises a time window transmitted on a physical sidelink control channel (PSCCH) within which the target SL-PRS is scheduled.

Example 13 is a baseband processor, including the subject matter of Example 11, wherein the resources for transmitting the target SL-PRS is sensed and selected by the reserve UE and transmitted to the target UE selection with up to two retransmission scheduled.

Example 14 is a baseband processor, including the subject matter of Example 13, wherein the resources for transmitting the target SL-PRS is prioritized by being flagged or set with a high priority level.

Example 15 is a baseband processor, including the subject matter of Example 11, wherein the resource selection information is transmitted to the target UE on a physical sidelink shared channel (PSSCH), wherein the resources for transmitting the target SL-PRS is indicated by a MAC-CE.

Example 16 is a baseband processor, including the subject matter of Example 11, further configured to cause the reserve UE to also transmit a first SL-PRS to the target UE on the PSSCH.

Example 17 is a baseband processor, including the subject matter of Example 11, further configured to cause the reserve UE to receive and measure the target SL-PRS from the target UE.

Example 18 is a baseband processor, including the subject matter of Example 11, wherein the resources includes a (pre)configured number of sub-slots, wherein a size of symbols for a sub-slot is pre-defined.

Example 19 is a baseband processor, including the subject matter of Example 11, wherein the resources includes a (pre)configured number of sub-channels, wherein a size of resource.

Example 20 is a method for resource allocation by a first User Equipment (UE). The method comprises receive, from an assist UE, inter-UE coordination information for allocating resources for transmitting a sidelink positioning reference signal (SL-PRS), determine, based on the inter-UE coordination information, resources from a dedicated resource pool for transmitting the SL-PRS, and transmit the SL-PRS using the resources determined from the dedicated resource pool. A physical sidelink shared channel (PSSCH) or a physical sidelink feedback channel (PSFCH) is configured for communicating the inter-UE coordination information.

Example 21 is a baseband processor, including the subject matter of Example 20, wherein the PSSCH or the PSFCH is configured in the dedicated resource pool for transmitting the inter-UE coordination information.

Example 22 is a baseband processor, including the subject matter of Example 20, wherein a dedicated pool resource of a dedicated resource pool is configured with a specific shared pool resource of a shared resource pool for transmitting the inter-UE coordination information.

Example 23 is a baseband processor, including the subject matter of Example 20, wherein the inter-UE coordination information is transmitted on the PSSCH and/or the PSFCH, if a resource is acquired in a shared resource pool.

Example 24 is a baseband processor, including the subject matter of Example 20, wherein the inter-UE coordination information is transmitted on PSSCH and indicates SL-PRS resources reserved by another UE.

Example 25 is a baseband processor, including the subject matter of Example 20, further comprising, transmit, to the assist UE, resource reservation of the first UE on PSCCH. The inter-UE coordination information is transmitted on physical sidelink feedback channel (PSFCH) and indicates presence of potential SL-PRS resource conflict of the resource reservation of the first UE and a resource reservation of another UE not directly received by the first UE.

Example 26 is a method that includes any action or combination of actions as substantially described herein in the Detailed Description.

Example 27 is a method as substantially described herein with reference to each or any combination of the Figures included herein or with reference to each or any combination of paragraphs in the Detailed Description.

Example 28 is a user equipment configured to perform any action or combination of actions as substantially described herein in the Detailed Description as included in the user equipment.

Example 29 is a network node configured to perform any action or combination of actions as substantially described herein in the Detailed Description as included in the network node.

Example 30 is a non-volatile computer-readable medium that stores instructions that, when executed, cause the performance of any action or combination of actions as substantially described herein in the Detailed Description.

Example 31 is a baseband processor of a user equipment configured to perform any action or combination of actions as substantially described herein in the Detailed Description as included in the user equipment.

Example 32 is a baseband processor of a network node configured to perform any action or combination of actions as substantially described herein in the Detailed Description as included in the user equipment.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor for a first User Equipment (UE), the baseband processor configured to execute instructions stored in one or more memories and perform operations comprising:
decoding congestion control information for a sidelink positioning reference signal (SL-PRS) communication to a second UE;
determine resources for the SL-PRS communication;
performing congestion handling based on the congestion control information; and
after performing the congestion handling, performing the SL-PRS communication on the resources.

2. The baseband processor of claim 1,
wherein the congestion handling is further based on a SL-PRS channel occupancy ratio (CR) and/or a SL-PRS channel busy ratio (CBR) for the SL-PRS; and
wherein the SL-PRS CR or the SL-PRS CBR is evaluated separately for shared resource pools and dedicated resource pools.

3. The baseband processor of claim 2, wherein the SL-PRS CR or the SL-PRS CBR is evaluated by normalizing a resource size based on a number of allocated or configured resources for the SL-PRS communication.

4. The baseband processor of claim 2, wherein the SL-PRS CR or the SL-PRS CBR is evaluated using a time window separately configured from a time window for CR or CBR of sidelink communication.

5. The baseband processor of claim 2,
wherein the SL-PRS CR or the SL-PRS CBR is evaluated in a slot n, where n is prior to a first slot m determined for the SL-PRS communication by a congestion control processing time N, and
wherein the congestion control processing time N is a UE capability separately implemented from a congestion control processing time N′ of sidelink communication.

6. The baseband processor of claim 1, wherein the congestion handling comprises one or more of: reducing an amount of retransmissions of the SL-PRS communication, reducing a transmission power of the SL-PRS communication, increasing a comb-size of the resources for the SL-PRS communication, or reducing a number of the resources for the SL-PRS communication.

7. The baseband processor of claim 1,
wherein the congestion control information comprises a plurality of SL-PRS channel occupancy ratio (CR) limits, and
wherein the plurality of SL-PRS CR limits is (pre)configured respectively associated with a series of priority levels in a resource pool.

8. The baseband processor of claim 7, wherein a SL-PRS CR for the SL-PRS is a sum of all SL-PRS CRs evaluated in a slot n, where n is prior to a first slot m determined for the SL-PRS communication by a congestion control processing time N.

9. The baseband processor of claim 7, wherein a SL-PRS CR for the SL-PRS is a sum of all SL-PRS CRs evaluated in a slot n associated with priority levels lower than a priority level allocated to the SL-PRS communication.

10. The baseband processor of claim 1,
wherein the congestion control information comprises a channel busy ratio (CBR) threshold; and
wherein the congestion handling comprises modifying parameters or stopping the SL-PRS communication if a CBR for the SL-PRS communication exceeds the CBR threshold.

11. A baseband processor for a reserve User Equipment (UE), the baseband processor configured to, when executing instructions stored in one or more memories, cause the reserve UE to:
receive configuration information for a sidelink positioning reference signal (SL-PRS) communication for a target UE; and
transmit, based on the configuration information, resource selection information to the target UE to indicate resources for the SL-PRS communication.

12. The baseband processor of claim 11, wherein the resource selection information comprises a time window transmitted on a physical sidelink control channel (PSCCH) within which the SL-PRS communication is scheduled.

13. The baseband processor of claim 11, wherein the resources for the SL-PRS communication is sensed and selected by the reserve UE and transmitted to the target UE with up to two retransmission scheduled.

14. The baseband processor of claim 13, wherein the resources for the SL-PRS communication is prioritized by being flagged or set with a high priority level.

15. The baseband processor of claim 11,
wherein the resource selection information is transmitted to the target UE on a physical sidelink shared channel (PSSCH); and
wherein the resources for the SL-PRS communication is indicated by a MAC-CE.

16. The baseband processor of claim 15, further configured to cause the reserve UE to perform the SL-PRS communication on the PSSCH.

17. The baseband processor of claim 11, further configured to cause the reserve UE to receive and measure a target SL-PRS from the target UE.

18. The baseband processor of claim 11, wherein the resources includes a (pre)configured number of sub-slots, wherein a size of symbols for a sub-slot is pre-defined.

19. The baseband processor of claim 11, wherein the resources includes a (pre)configured number of sub-channels, wherein a size of resource blocks (RBs) for a sub-channel is pre-defined.

20. A method for resource allocation by a first User Equipment (UE), comprising:
receiving, from an assist UE, inter-UE coordination information for allocating resources for transmitting a sidelink positioning reference signal (SL-PRS);
determining, based on the inter-UE coordination information, resources from a dedicated resource pool for transmitting the SL-PRS; and
transmitting the SL-PRS using the resources determined from the dedicated resource pool;
wherein a physical sidelink shared channel (PSSCH) or a physical sidelink feedback channel (PSFCH) is configured for communicating the inter-UE coordination information.

21-25. (canceled)
